(19) United States
(12) Patent Application Publication
(10) Pub. No.: US 2007/0203947 A1
(43) Pub. Date: Aug. 30, 2007

(54) Method for Providing Internet Service Employing User Personal Distance Information

(76) Inventor: Weishi Feng, San Jose, CA (US)

Correspondence Address: WARN, HOFFMANN, MILLER & LALONE, .P.C, PO BOX 70098, ROCHESTER HILLS, MI, 48307, US

(21) Appl. No.: 11/678,280

(22) Filed: Feb. 23, 2007

Related U.S. Application Data
(60) Provisional application No. 60/776,894, filed on Feb. 27, 2006.

(51) Int. Cl. G06F 7/00

(52) U.S. Cl. 707/104.1

(57) ABSTRACT

A method for providing Internet services employing contact personal distance information by classifying contacts in a user's contact list with a certain classification. The method includes providing a contact list for each user that has an account with the service provider, and providing a personal distance classification for contacts in the contact list that identifies personal information between the user and the contacts in the contact list. The user can use the personal distance classification to allow the user to selectively communicate with the contacts in the contact list over the Internet using the classification. In one non-limiting embodiment, the personal distance classification includes classifying the contacts in the contact list as family members, friends or business associates.

### CROSS REFERENCE TO RELATED APPLICATIONS

This application claims the benefit of the priority date of U.S. Provisional Patent Application No. 60/776,894, titled Contact List and Internet Services Based on the Improved Contact List, filed Feb. 27, 2006.

### BACKGROUND OF THE INVENTION

1. Field of the Invention

This invention relates generally to a method for providing Internet services employing contact personal distance information and, more particularly, to a method for providing Internet services employing contact personal distance information by classifying contacts in a user's contact list with a certain classification.

2. Discussion of The Related Art

E-mail is a popular mechanism for allowing e-mail users to communicate with each other over the Internet. Typically, a user will have an “address book” or “contact list” provided by the e-mail software that allows the user to store contact information of other users, both personal and business, from which the user can easily select an addressee to send an e-mail message. However, e-mail allows various people and entities, some less than honorable, to send messages to users in an attempt to sell various products and services. This type of e-mail message is generally referred to in the industry as “spam.” Further, various nefarious entities use e-mail to spread computer viruses to disrupt the flow of information and data. These nefarious entities can gain access to the e-mail of honorable users in many ways, including through legitimate e-mail transmissions.

Internet e-mail service providers generally use some type of spam filtering that attempts to prevent unwanted e-mails from being delivered to a user. Various types of spam filtering techniques are known in the art, most of which have limited success.

### SUMMARY OF THE INVENTION

In accordance with the teachings of the present invention, a method for providing Internet services employing contact personal distance information is disclosed that includes classifying contacts in a user's contact list with a certain distance classification. The method includes providing a contact list for each user that has an account with the service provider, and providing a personal classification for contacts in the contact list that identifies personal distance information between the user and the contacts in the contact list. The user can use the personal distance classification to allow the user to selectively communicate with the contacts in the contact list over the Internet using the classification. In one non-limiting embodiment, the personal distance classification includes classifying the contacts in the contact list as family members, friends or business associates.

Additional features of the present invention will become apparent from the following description and appended claims, taken in conjunction with the accompanying drawings.

### BRIEF DESCRIPTION OF THE DRAWINGS

FIGS. 1(a)-1(c) are a representation of contact lists for three users;

FIG. 2 is a flow chart diagram showing a method for determining what e-mail messages will be sent to a user and what e-mails will be rejected depending on whether the sender is identified on user controlled and service provider controlled access lists, according to an embodiment of the present invention; and

FIG. 3 is a flow chart diagram showing a method for performing an authorization process to determine whether to send an e-mail message to a user if the sender does not appear on any of the lists in the method shown in FIG. 2.

### DETAILED DESCRIPTION OF THE EMBODIMENTS

The following discussion of the embodiments of the invention directed to a method for providing Internet services employing contact personal distance information by classifying contacts in the user's contact list with a certain classification is merely exemplary in nature, and is in no way intended to limit the invention or its application or uses.

An Internet service provider is a company or organization who owns and operates hardware and software systems that provide e-mail and other Internet services, such as instant messaging, electronic message boards, etc., for users who subscribe to the service. A user subscribes with the service provider by creating an account so that the user can log into and use the services.

According to one embodiment of the invention, an algorithm is provided by the Internet service provider that allows the user to establish a user contact list that includes personal distance information that identifies how close an entity or person, as represented by a certain entry in the contact list, is to the user. The personal distance information could be specified by any suitable manner, such as by numerical ordering or by a particular classification, such as family member, friend, business associate, etc. The personal distance information can be specified by the user or can be determined by the system software if the user enables that feature. Thus, selective networks can be established between and among Internet users.

For example, the user can build one or more “friend circles” in his/her contact list, where each friend circle is a group of friends. One person can be put into multiple friend circles. The contact information for a particular person can be stored as a reference, where what actually is stored in the contact list is a pointer that points to the data storage area where the actual contact information is stored. In this manner, if a user updates his/her contact information, such as phone numbers or addresses, all of the other users in the friend circle, or other classification, will have their contact list automatically updated if the users enable the feature.

According to one aspect of this embodiment, the algorithm may provide a friend talk service, where the user can post a message on an electronic message board to a certain designation of contacts in his/her contact list, such as a friend circle. For example, a user may want a certain group of contacts to view a certain website, review a certain publication, or get other information over the Internet. The user will post a message on the electronic message board that directs the selected contacts to a particular website, who will get an alert message when they “log in” to their account. Particularly, the user can classify the message according to who he/she wants to see it from his/her contact list. Based on this process, an on-line social network can be provided where the users that are part of the network have a mutual trust in that they specifically know the persons who will view the messages.

The user can further specify whether the message will be visible to friend's friends, that is, whether the message will be available to those people designated as friends in the receiving user's contact list. The user can also specify whether the message will be visible to friend's friend's friends, or even visible to the public.

According to another aspect of this embodiment of the invention, the algorithm may allow a user to make a recommendation of a product, article, piece of news, etc., and the user can specify whether the recommendation is visible to any of the groups identified above.

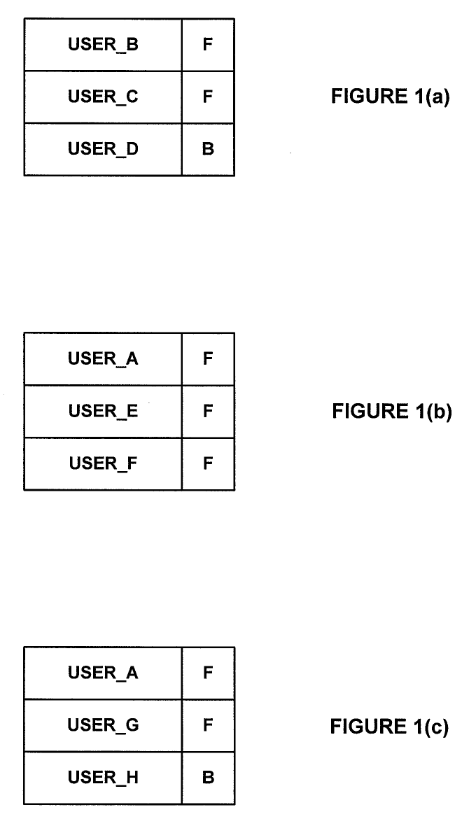

An example of the above-described personal distance information contact list is shown in FIGS. 1(a)-1(c), where FIG. 1(a) is a contact list for user_A, FIG. 1(b) is a contact list for user_B, and FIG. 1(c) is a contact list for user_C. Suppose, for example, the personal distance information classification has two levels, the letter F identifies a friend and the letter B identifies a business associate. In this example, a friend is closer in personal distance to the user than a business associate. User_A has a contact list that classifies user_B and user_C as friends, and user_D as a business associate. User_B has a contact list that classifies user_A, user_E and user_F as friends. User_C has a contact list that classifies user_A and user_G as friends, and user_H as a business associate.

If user_A posts a message on the message board, or makes a recommendation, and specifies the message is for friends only, then only user_B and user_C can see the message and join a discussion, such as a chat room, concerning the message with each other. If user_A posts a message on the message board, or makes a recommendation, and specifies the message is for friend's friends, then all of user_B, user_C, user_E and user_G will be able to receive the message. If user_A posts a message on the message board, or makes a recommendation, and specifies the message is for the public, then all of the users can see the message and join a discussion concerning the message.

According to another embodiment of the invention, an algorithm is provided by the e-mail service provider that provides spam rejection based on user controlled access lists and service provider controlled access lists. The user controlled access lists include a contact list that contains contact information of the user's family, friends, business associates, and other people or entities that are permitted to send e-mail to the user based on account information. E-mail messages from people and entities on the contact list are passed directly to the user by the service provider algorithm. The contact list can include full email addresses, partial email addresses or domain names. For example, the user may want to receive all email messages from xyz.com. Also, the user may want to accept all email messages from a certain domain, such as .edu.

The user controlled access lists also include a reject list that is loaded by the user. The service provider will reject and discard messages from people or organizations on the reject list, and not pass them to the user.

Other people or entities may send e-mail messages to the user who may not be on the user's contact list or reject list. The service provider controlled access lists include an honorable business list, where honorable businesses and organizations can register with the service provider so that their messages to the users that subscribe to the service can be passed to the users. Honorable businesses are those businesses that may have legitimate business with a user. The honorable businesses or organizations may have to pay the service provider for the delivery of their messages to the users. If a business or person on the honorable business list sends spam e-mail messages to the users, the service provider can remove the business or person from the honorable business list so that spam messages from the business will not be passed to the users in the future. The user can choose to enable or disable the honorable business list feature. If a user disables the honorable business list feature, messages from a business or person who is not on the user's contact or reject list, but is on the honorable business list, will need to be authorized by the user before being delivered to the user, as will be discussed in further detail below.

The service provider also assigns an honorable user status to each user that has an account with the service provider who does not send spam e-mail messages. As described herein, those users that have been assigned the honorable user status are said to be on an honorable user list. Each user who subscribes to the service provider can choose to accept messages from honorable users who are not on the user's contact list by enabling the honorable user feature. For example, suppose user_A is an honorable user, and user_A wishes to send an e-mail message to user_B. If user_B chooses to accept e-mail messages from honorable users by enabling the honorable user feature, then the message is passed to user_B even if user_A is not on user_B's contact list. However, if user_B chooses to disable the honorable user feature, the e-mail message from user_A will need to be authorized by the user before being delivered to the user, as will be discussed in further detail below.

According to the invention, the algorithm includes an authorization process for allowing an e-mail message to be sent to a user if the sender is not on the user's contact list, the user's reject list, the honorable business list or the honorable user list. Further, the authorization process can be used to authorize a message to a user from a sender that is on the honorable business list or on the honorable user list if the user has the honorable business and/or honorable user feature disabled. A detailed discussion of one example of a suitable authorization process is discussed below.

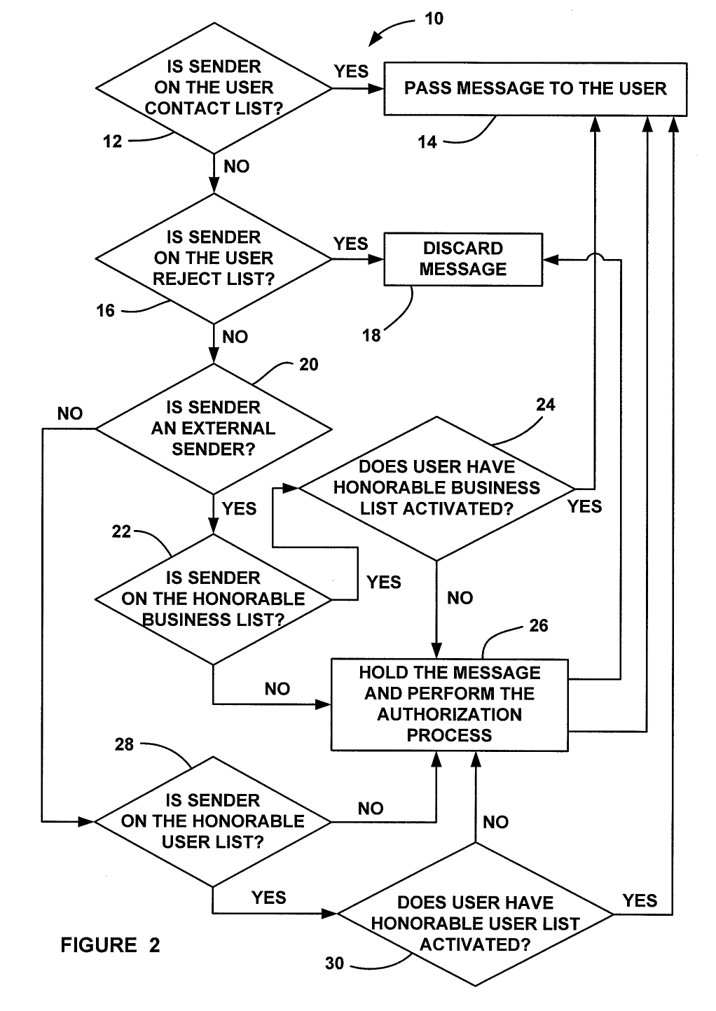

FIG. 2 is a flow chart diagram 10 showing a method for determining whether to pass an e-mail message by a service provider to a user based on the discussion above. The service provider algorithm determines whether the sender of the message is on the user contact list at decision diamond 12, and if so, the algorithm sends the message to the user at box 14. If the sender of the message is not on the user contact list at the decision diamond 12, then the algorithm determines whether the sender is on the user reject list at decision diamond 16. If the sender is on the user's reject list at the decision diamond 16, then the algorithm discards the message at box 18.

If the sender is not on the user's reject list at the decision diamond 16, the algorithm determines whether the sender is an external sender, i.e., does not have an account with the e-mail service provider, at decision diamond 20. If the sender is an external sender at the decision diamond 20, then the algorithm determines whether the sender is on the honorable business list at the decision diamond 22. If the sender is on the honorable business list at the decision diamond 22, and the user for who the message was intended has enabled the feature to allow messages from honorable businesses at decision diamond 24, then the algorithm sends the message to the user at the box 14. If the sender is on the honorable business list, but the user has disabled the honorable business list feature, then the algorithm holds the message and performs an authorization process to determine if the message will be sent to the user or discarded at box 26. If the sender is not on the honorable business list at the decision diamond 22, then the algorithm holds the message and performs the authorization process to determine if the message will be sent to the user or discarded at the box 26.

If the sender is an internal sender at the decision diamond 20, i.e., has an account with the service provider, then the algorithm determines whether the sender is on the honorable user list at decision diamond 28. If the user is on the honorable user list, and the user has enabled the honorable user feature at decision diamond 30, then the algorithm sends the message to the user at the box 14. If the sender is on the honorable user list at the decision diamond 28, but the user has disabled the honorable user feature at the decision diamond 30, then the algorithm holds the message and performs the authorization process to determine if the message will be sent to the user or discarded at the box 26. If the sender is not on the honorable user list at the decision diamond 28, then the algorithm holds the message and performs the authorization process to determine if the message will be sent to the user or discarded at the box 26.

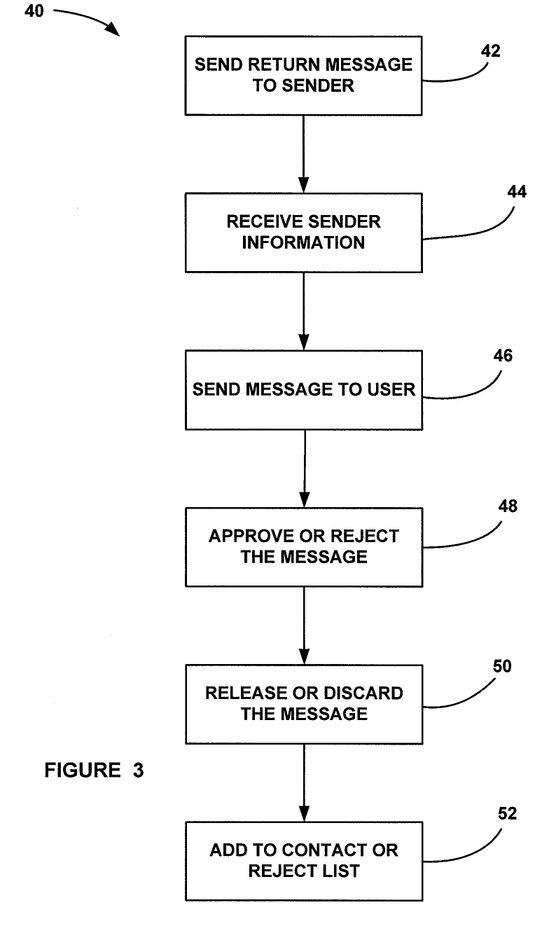

FIG. 3 is a flow chart diagram 40 showing one suitable operation for the authorization process at the box 26. Other authorization processes and additional steps can also be used within the scope of the present invention. While the algorithm is holding the message, the algorithm will send a new e-mail message to the sender stating that authorization is required before the original message is sent to the user at box 42. The message can contain an Internet link that leads the sender to a webpage to provide verifiable information, for example, the sender's name, how the sender found the user's e-mail address, etc. The algorithm can also ask the sender to perform a task that is easy for human beings, but difficult for computers, such as reading distorted English letters and numbers. The algorithm will then wait for the information from the sender and will receive the information at box 44. The algorithm will then send a message to the user indicating that there has been an attempt to send a message to the user together with the sender's information at box 46. The user will approve or deny the message at box 48, and the algorithm will send the message or discard the message appropriately at box 50. The user can add the sender information to his/her contact list or reject list at box 52.

The foregoing discloses and describes merely exemplary embodiments of the present invention. One skilled in the art will readily recognize from such discussion and from the accompanying drawings and claims, that various changes, modifications and variations can be made therein without departing from the spirit and scope of the present invention as defined by the following claims.

What is claimed is:

1. A method for classifying contacts for Internet users, said method comprising:
providing a contact list for each user that has an account with a service provider where the contact list includes an e-mail address for each contact;
providing a personal distance classification for contacts in the contact list that identifies personal distance information between the user and the contacts in the contact list; and
using the personal distance information to allow the user to selectively communicate with the contacts in the contact list over the Internet using the classification.

2. The method according to claim 1 wherein providing a personal distance classification includes classifying the contacts in the contact list as family members, friends or business associates.

3. The method according to claim 1 wherein providing a personal distance classification includes providing classifications that identify a plurality of friend circles for a single user.

4. The method according to claim 1 wherein communicating with contacts in the contact list includes designating in the communication accessibility to the communication to a certain classification of contacts and a certain classification in the contact list of the contacts.

5. The method according to claim 4 wherein the classification is friends and friend's friends.

6. The method according to claim 1 wherein the communication includes posting a message on an electronic message board, and designating which classification of contacts can have access to the message.

7. The method according to claim 1 wherein the communication includes e-mail messages.

8. The method according to claim 1 wherein the contact information for a contact in the contact list includes using a pointer that points to a data storage area where the contact information is stored.

9. The method according to claim 8 wherein a user of the service provider can update contact information in the contact list of other users based on the classification.

10. A method for providing a classification of contacts for Internet users, said method comprising:
providing a contact list for each user that has an account with a service provider;
providing a personal distance classification for contacts in the contact list that identifies personal distance information between the user and the contacts in the contact list, wherein the personal distance classification includes classifying the contacts in the contact list as family members, friends or business associates, and wherein providing a personal distance classification includes providing classifications that identify a plurality of friend circles for a single user; and
using the personal distance classification to allow the user to selectively communicate with the contacts in the contact list over the Internet.

11. The method according to claim 10 wherein communicating with contacts in the contact list includes designating in the communication accessibility to the communication to a certain classification of contacts and a certain classification in the contact list of the contacts.

12. The method according to claim 11 wherein the classification is friends and friend's friends.

13. The method according to claim 10 wherein the communication includes posting a message on an electronic message board, and designating which classification of contacts can have access to the message.

14. The method according to claim 10 wherein the communication includes e-mail messages.

15. The method according to claim 10 wherein the contact information for a contact in the contact list includes using a pointer that points to a data storage area where the contact information is stored.

16. The method according to claim 15 wherein a user of the service provider can update contact information in the contact list of other users based on the classification.

17. A method for providing Internet services including user personal distance information, said method comprising:
providing a contact list for each user that has an account with a service provider; and
assigning a personal distance classification for contacts in the contact list that identifies personal distance information between the user and the contacts in the contact list.

18. The method according to claim 17 wherein assigning a personal distance classification includes classifying the contacts in the contact list as family members, friends or business associates.

19. The method according to claim 17 wherein assigning a personal distance classification includes providing classifications that identify a plurality of friend circles for a single user.
